(19) United States
(12) Patent Application Publication
(10) Pub. No.: US 2024/0095501 A1
(43) Pub. Date: Mar. 21, 2024

(54) MULTI-MODAL ADAPTIVE FUSION DEEP CLUSTERING MODEL AND METHOD BASED ON AUTO-ENCODER

(71) Applicant: ZHEJIANG NORMAL UNIVERSITY, Jinhua (CN)

(72) Inventors: Xinzhong ZHU, Jinhua (CN); Huiying XU, Jinhua (CN); Shihao DONG, Jinhua (CN); Xifeng GUO, Jinhua (CN); Xia WANG, Jinhua (CN); Lintong JIN, Jinhua (CN); Jianmin ZHAO, Jinhua (CN)

(73) Assignee: ZHEJIANG NORMAL UNIVERSITY, Jinhua (CN)

(21) Appl. No.: 18/273,783

(22) PCT Filed: Nov. 17, 2021
(86) PCT No.: PCT/CN2021/131248

§ 371 Date: Jul. 24, 2023

(30) Foreign Application Priority Data
Jan. 25, 2021 (CN) 202110096080.5

(51) Int. Cl. G06N 3/0455; G06N 3/0464; G06N 3/084

(52) U.S. Cl. CPC G06N 3/0455; G06N 3/0464; G06N 3/084

(57) ABSTRACT

A multi-modal adaptive fusion deep clustering model based on an auto-encoder includes an encoder structure, a multi-modal adaptive fusion layer, a decoder structure and a deep embedding clustering layer. The encoder is configured to enable a dataset to be respectively subjected to three types of nonlinear mappings of the auto-encoder, a convolutional auto-encoder and a convolutional variational auto-encoder to obtain potential features, respectively. The multi-modal adaptive feature fusion layer is configured to fuse the potential features into a common subspace in an adaptive spatial feature fusion mode to obtain a fused feature. The decoder is configured to decode the fused feature by using a structure symmetrical to the encoder to obtain a decoded reconstructed dataset. The deep embedding clustering layer is configured to cluster the fused feature Z and obtain a final accuracy ACC by comparing a clustering result with a true label.

### CROSS REFERENCE TO THE RELATED APPLICATIONS

This application is the national phase entry of International Application No. PCT/CN2021/131248, filed on Nov. 17, 2021, which is based upon and claims priority to Chinese Patent Application No. 202110096080.5, filed on Jan. 25, 2021, the entire contents of which are incorporated herein by reference.

### TECHNICAL FIELD

The present application relates to the technical field of clustering analysis, in particular to a multi-modal adaptive fusion deep clustering model and method based on an auto-encoder.

### BACKGROUND

Clustering analysis is a fundamental problem in many fields, such as machine learning, data mining, pattern recognition, image analysis, and biological information. Clustering is to divide similar objects into different groups or more subsets by a static classification method, so that member objects in the same subset have similar attributes, and data clustering is generally generalized to unsupervised learning. There are some common clustering methods in a prior art, but a similarity measurement method used in a traditional clustering method is low in efficiency; therefore, the performance of the methods on high-dimensional data is generally poor. In addition, these methods typically have a high computational complexity on large-scale datasets. Therefore, dimension reduction and feature transformation methods have been extensively studied to map original data into a new feature space, and in the feature space, the generated data is more prone to being separated by an existing classifier. Generally, an existing data transformation method includes linear transformation (e.g., principal component analysis) and nonlinear transformation (e.g., a nuclear method and a spectral method). Nevertheless, the highly complex latent structure of data still challenges the effectiveness of the existing clustering method.

Due to the development of deep learning, a deep neural network can be used to convert the data into a representation more prone to being clustered due to inherent properties of highly nonlinear conversion of the deep neural network. In recent years, the clustering method also involves deep embedding clustering and other novel methods, so that the deep clustering becomes a popular research field. Such as a stacked auto-encoder, a variable auto-encoder and a convolutional auto-encoder, which are proposed for unsupervised learning. The neural network-based clustering method defeats the traditional method to a certain extent, and is an effective method for learning complex nonlinear transformation to obtain strong features. However, the single-modal method of acquiring features through a neural network, that is, firstly extracting a modal feature, and then using traditional clustering, such as K-means or spectral clustering, does not fully extract all features of the data, and does not well utilize the relationship between multi-modal feature learning and clustering; therefore, such a single learning strategy may bring an unsatisfactory clustering result, and the result even changes greatly due to the disadvantage of unsupervised learning. In order to solve the problem, the present application provides a multi-modal adaptive feature fusion deep clustering model and a clustering method based on an auto-encoder.

### SUMMARY

The present application aims to provide, for the defects of the prior art, a multi-modal adaptive fusion deep clustering model and method based on an auto-encoder. Potential representations of original data are learned using a plurality of different deep auto-encoders, and the deep auto-encoders are constrained to learn different features. Experimental evaluation of a plurality of natural image datasets shows a significant improvement of the method over the existing methods.

To achieve the above objective, the present application adopts the following technical solutions:
the multi-modal adaptive fusion deep clustering model based on an auto-encoder includes an encoder, a multi-modal adaptive fusion layer, a decoder and a deep embedding clustering layer; and the encoder includes an auto-encoder, a convolutional auto-encoder and a convolutional variational auto-encoder;
the encoder is configured to enable a dataset X to be respectively subjected to nonlinear mappings h(X; θₘ) of the auto-encoder, the convolutional auto-encoder and the convolutional variational auto-encoder to obtain potential features Zₘ of the auto-encoder, the convolutional auto-encoder and the convolutional variational auto-encoder, respectively;
the multi-modal adaptive fusion layer is connected with the encoder and is configured to fuse the respectively obtained potential features Zₘ of the auto-encoder, the convolutional auto-encoder and the convolutional variational auto-encoder into a common subspace in an adaptive spatial feature fusion mode to obtain a fused feature Z;
the decoder is connected with the multi-modal adaptive fusion layer and is configured to decode the fused feature Z by using a structure symmetrical to the encoder to obtain a decoded reconstructed dataset X̅; and
the deep embedding clustering layer is connected with the multi-modal adaptive fusion layer and is configured to cluster the fused feature Z and obtain a final accuracy ACC by comparing a clustering result with a true label.

Furthermore, the respectively obtained potential features Zₘ of the auto-encoder, the convolutional auto-encoder and the convolutional variational auto-encoder in the encoder are expressed as:

Zₘ=h(X;θₘ)
wherein θₘ represents an encoder model parameter; and m represents an encoder sequence.

Furthermore, the fused feature Z obtained in the multi-modal adaptive fusion layer is expressed as:

Z=ω₁·Z₁+ω₂·Z₂+ω₃·Z₃
wherein ωₘ represents an importance weight of the feature of the mth modal, and an adaptive feature fusion parameter is obtained by means of adaptive learning of a network;
Σₘ₌₁³ωₘ=1, ωₘ∈[0, 1] is limited, and

$${ω}_{m} = \frac{{e}^{{β}_{m}}}{{e}^{{β}_{1}} + {e}^{{β}_{2}} + {e}^{{β}_{3}}}$$

is defined,
wherein to ωₘ is defined by using a softmax function with βₘ m as a control parameter, respectively; and a weight scalar βₘ is calculated by using 1×1 convolution on different modal features, respectively, and learning is achieved by means of standard back propagation.

Furthermore, the decoded reconstructed dataset X̅ obtained in the decoder is expressed as:

X̅=g(Z;θₘ)
wherein θₘ represents a decoder model parameter.

Furthermore, clustering the fused feature Z in the deep embedding clustering layer specifically includes:
dividing n points {xᵢ∈X}ᵢ₌₁ⁿ into k classes, using μⱼ, j=1, . . . , k for the center of each class, initializing a clustering center {μⱼ}ⱼ₌₁^{k}, calculating a soft assignment qᵢⱼ and an auxiliary distribution pᵢ of the feature points and the clustering center, finally defining a clustering loss function by using a Kullback-Leibler (KL) divergence of the soft assignment qᵢⱼ and auxiliary distribution pᵢ, and updating the clustering center uⱼ, the encoder, the decoder parameter θ and the adaptive feature fusion parameter β.

Furthermore, the encoder further includes updating network parameters of the auto-encoder, the convolutional auto-encoder and the convolutional variational auto-encoder by using a reconstruction loss, which specifically includes using a square error function of original dataxᵢinput by the encoder and reconstruction datax̅ᵢoutput by the decoder as the reconstruction loss, pre-training the encoder, and obtaining an initialized model and expressing same as:

$${L}_{R} = {min}_{θ , ϑ , β} {\sum }_{i = 1}^{n} {‖ \overline{{x}_{i}} - {x}_{i} ‖}^{2}$$

wherein L_{R} represents a reconstruction loss function.

Furthermore, the deep embedding clustering layer further includes updating the clustering result, encoder parameter and fusion parameter by using a KL divergence of the clustering loss, which specifically includes:
using a student t assignment as a kernel function to calculate a similarity between the feature point Zᵢ and the clustering center μⱼ, which is expressed as:

$${q}_{ij} = \frac{{( 1 + {‖ {Z}_{i} - {μ}_{j} ‖}^{2} / α )}^{- \frac{α + 1}{2}}}{{\sum }_{{j}^{′}} {( 1 + {‖ {Z}_{i} - {μ}_{{j}^{′}} ‖}^{2} / α )}^{- \frac{α + 1}{2}}}$$

wherein Zᵢ=∫(h(xᵢ))∈Z; α represents a degree of freedom of the student t assignment; qᵢⱼ represents a probability of assigning a sample i to the clustering center μⱼ; and μⱼ represents each center point; and
iteratively optimizing the clustering by learning from a high confidence assignment of the clustering with the help of an auxiliary target assignment, i.e., training the model by matching the soft assignment to the target assignment, and defining an objective loss function as the KL divergence between the soft assignment probability qᵢ and the auxiliary distribution pᵢ, expressed as:

$${L}_{C} = KL ( P ∥ Q ) = {\sum }_{i} {\sum }_{j} {p}_{ij} log \frac{{p}_{ij}}{{q}_{ij}} \\ {p}_{ij} = \frac{{q}_{ij}^{2} / {f}_{j}}{{\sum }_{{j}^{′}} {q}_{{ij}^{′}}^{2} / {f}_{{j}^{′}}} \\ {f}_{j} = {\sum }_{i} {q}_{ij}$$

wherein L_{C} represents a clustering loss function, and fⱼ=Σᵢqᵢⱼ represents a soft clustering frequency.

Furthermore, the deep embedding clustering layer further includes:
jointly optimizing the clustering center μⱼ, network parameter θ and adaptive feature fusion parameter β by means of a stochastic gradient descent algorithm with momentum, and calculating an L gradient embedded into a feature space of each data point Zᵢ and each clustering center μⱼ as follows:

$$\frac{\partial L}{\partial {Z}_{i}} = \frac{α + 1}{α} {\sum }_{j} {( 1 + \frac{{‖ {z}_{i} - {μ}_{j} ‖}^{2}}{α} )}^{- 1} \times ( {p}_{ij} - {q}_{ij} ) ( {z}_{i} - {μ}_{j} )$$

$$\frac{\partial L}{\partial {μ}_{j}} = - \frac{α + 1}{α} {\sum }_{i} {( 1 + \frac{{‖ {z}_{i} - {μ}_{j} ‖}^{2}}{α} )}^{- 1} \times ( {p}_{ij} - {q}_{ij} ) ( {z}_{i} - {μ}_{j} )$$

wherein the gradient ∂L/∂Zᵢ is subjected to back propagation to calculate a network parameter gradient ∂L/∂θ, and when the number of points with the clustering assignment changed between two continuous iterations is smaller than a preset proportion of the total number of points, the clustering is stopped.

Correspondingly, a multi-modal adaptive fusion deep clustering method based on an auto-encoder is also provided, and includes:
S1, enabling a dataset X to be respectively subjected to nonlinear mappings h(X; θₘ) of an auto-encoder, a convolutional auto-encoder and a convolutional variational auto-encoder to respectively obtain potential features Zₘ of the auto-encoder, the convolutional auto-encoder and the convolutional variational auto-encoder;
S2, fusing the respectively obtained potential features Zₘ of the auto-encoder, the convolutional auto-encoder and the convolutional variational auto-encoder into a common subspace in an adaptive spatial feature fusion mode to obtain a fused feature Z;
S3, decoding the clustered fused feature Z by using a structure symmetrical to the encoder to obtain a decoded dataset X̅; and
S4, clustering the adaptive fused feature Z, and obtaining a final accuracy ACC by comparing a clustering result with a true label.

Furthermore, the fused feature Z obtained in S2 is expressed as:

Z=ω₁·Z₁+ω₂·Z₂+ω₃·Z₃
wherein ωₘ represents an importance weight of the feature of the mth modal, and an adaptive feature fusion parameter is obtained by means of adaptive learning of a network;
Σₘ₌₁³ωₘ=1, ωₘ∈[0, 1] is limited, and

$${ω}_{m} = \frac{{e}^{{β}_{m}}}{{e}^{{β}_{1}} + {e}^{{β}_{2}} + {e}^{{β}_{3}}}$$

is defined,
wherein ωₘ is defined by using a softmax function with βₘ in as a control parameter, respectively; and a weight scalar βₘ is calculated by using 1×1 convolution on different modal features, respectively, and learning is achieved by means of standard back propagation.

Compared with the prior art, the present application provides a novel multi-modal adaptive feature fusion deep clustering framework, and the framework includes a multi-modal encoder, an adaptive fusion network and a deep clustering layer. Through the multi-modal encoder and the multi-modal adaptive feature fusion layer, the model extracts original data features by means of nonlinear mapping, fulfills high-dimensional data dimensionality reduction, optimizes the common subspace of the data features, and finally constrains subspace clustering by using the KL divergence. Experimental results on three common datasets demonstrated that our model outperformed a plurality of the latest models.

### BRIEF DESCRIPTION OF THE DRAWINGS

FIG. 1 is a structural diagram of a multi-modal adaptive fusion deep clustering model based on an auto-encoder according to Embodiment I;

FIG. 2 is a structural schematic diagram of multi-modal deep clustering (MDEC) based on an auto-encoder according to Embodiment I;

FIG. 3 is a schematic diagram of specific dataset information and sample information according to Embodiment II; and

FIG. 4 is a schematic diagram of a multi-modal adaptive fusion deep clustering method based on an auto-encoder according to Embodiment III.

### DETAILED DESCRIPTION OF THE EMBODIMENTS

The embodiments of the present application are illustrated below through specific examples, and other advantages and effects of the present application can be easily understood by those skilled in the art based on the contents disclosed herein. The present application can also be implemented or applied through other different specific embodiments. Various modifications or changes to the details described in the specification can be made based on different perspectives and applications without departing from the spirit of the present application. It should be noted that, unless conflicting, the embodiments and features of the embodiments may be combined with each other.

The present application aims to provide, for the defects of the prior art, a multi-modal adaptive fusion deep clustering model and method based on an auto-encoder.

### Embodiment I

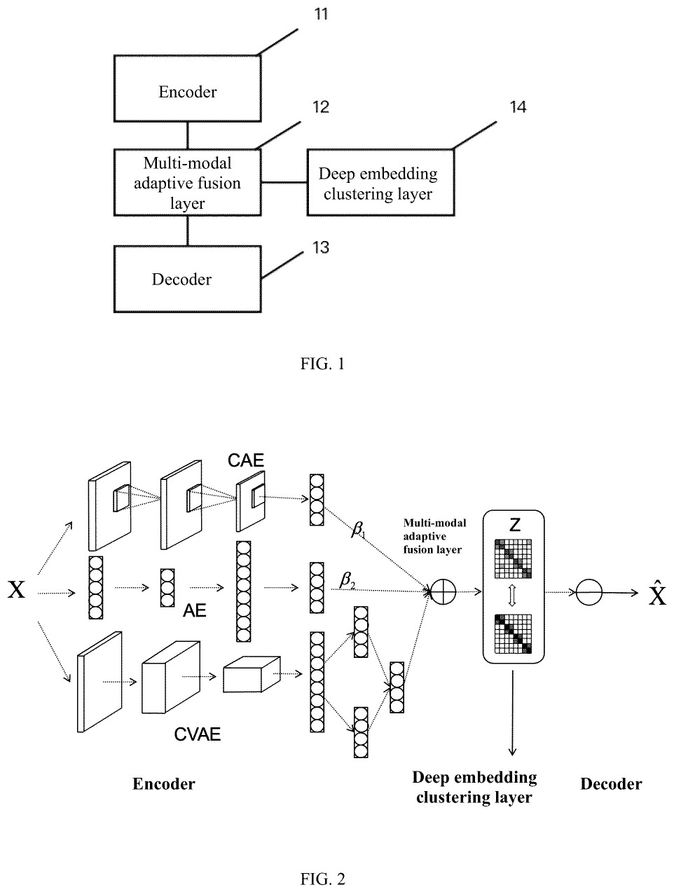

Provided in the embodiment is a multi-modal adaptive fusion deep clustering model based on an auto-encoder, as shown in FIG. 1, including an encoder 11, a multi-modal adaptive fusion layer 12, a decoder 13, and a deep embedding clustering layer 14; the encoder 11 includes an auto-encoder, a convolutional auto-encoder, and a convolutional variational auto-encoder;
the encoder 11 is configured to enable a dataset X to be respectively subjected to nonlinear mappings h(X; θₘ) of the auto-encoder, the convolutional auto-encoder and the convolutional variational auto-encoder to respectively obtain potential features Zₘ of the auto-encoder, the convolutional auto-encoder and the convolutional variational auto-encoder;
the multi-modal adaptive fusion layer 12 is connected with the encoder 11 and is configured to fuse the respectively obtained potential features Zₘ of the auto-encoder, the convolutional auto-encoder and the convolutional variational auto-encoder into a common subspace in an adaptive spatial feature fusion mode to obtain a fused feature Z;
the decoder 13 is connected with the multi-modal adaptive fusion layer 12 and is configured to decode the clustered fused feature Z by using a structure symmetrical to the encoder to obtain a decoded reconstructed dataset X̅; and
the deep embedding clustering layer 14 is connected with the multi-modal adaptive fusion layer 12 and is configured to cluster the fused feature Z to obtain the clustered fused feature Z.

FIG. 2 is a structural schematic diagram of multi-modal adaptive feature fusion deep clustering (MDEC) based on an auto-encoder, where the structure is composed of four parts: an encoder 11 composed of an auto-encoder, a convolutional auto-encoder and a convolutional variational auto-encoder; a multi-modal adaptive fusion layer 12; a deep embedding clustering layer 13; and a decoder 14.

In the encoder 11, the dataset X is subjected to nonlinear mappings h(X; θₘ) of the auto-encoder, the convolutional auto-encoder, and the convolutional variational auto-encoder, respectively, to obtain potential features Zₘ of the auto-encoder, the convolutional auto-encoder, and the convolutional variational auto-encoder, respectively.

Specifically, in the model, X is used to represent the dataset, and the potential features Zₘ are obtained by means of nonlinear mappings h(X; θₘ) of the auto-encoder, the convolutional auto-encoder and the variational auto-encoder, respectively. The high-dimensional data can be converted into a low-dimensional feature by the encoder, and the expression is as follows:

Zₘ=h(X;θₘ)
wherein θₘ represents an encoder model parameter; and m represents an encoder sequence.

In the multi-modal adaptive fusion layer 12, the respectively obtained potential features Zₘ of the auto-encoder, the convolutional auto-encoder and the convolutional variational auto-encoder are fused into a common subspace in an adaptive spatial feature fusion mode to obtain a fused feature Z.

Specifically, after mapping of an encoder layer, three potential feature spaces Zₘ are obtained, and in order to acquire more comprehensive information of the original data, different features Zₘ acquired by different auto-encoders are fused into the common subspace Z, and the formula is as follows:

Z=ω₁·Z₁+ω₂·Z₂+ω₃·Z₃
wherein ωₘ represents an importance weight of the feature of the mth modal, and an adaptive feature fusion parameter is obtained by means of adaptive learning of a network;
Eₘ₌₁³ωₘ=1, ωₘ∈[0, 1] is limited, and

$${ω}_{m} = \frac{{e}^{{β}_{\overline{m}}}}{{e}^{{β}_{1}} + {e}^{{β}_{2}} + {e}^{{β}_{3}}}$$

is defined,
wherein ωₘ is defined by using a softmax function with βₘ as a control parameter, respectively; and a weight scalar βₘ is calculated by using 1×1 convolution on different modal features, respectively, and learning is achieved by means of standard back propagation.

In the decoder 13, the clustered fused feature Z is decoded using a structure symmetrical to the encoder to obtain a decoded dataset.

Specifically, in order to better learn the features Z of the original data X, the structure symmetrical to the encoder is used to decode:

X̅=g(Z;θₘ)
wherein X̅ represents a reconstruction of the dataset X; and θₘ represents a decoder model parameter.

In the deep embedding clustering layer 14, the fused feature Z is clustered, and a final accuracy ACC is obtained by comparing a clustering result with a true label.

Specifically, thinking of DEC “J. Xie, R. Girshick, and A. Farhadi, “Unsupervised deep embedding for clustering analysis,” in Proc. Int. Conf. Mach. Learn., 2016, pp. 478-487” is used as a reference for the clustering layer, {xᵢ∈x}ᵢ₌₁ⁿ is divided into k classes, and μⱼ=1, . . . , k is used for the center of each class as a representation. For clustering the fused feature Z, the clustering center {μⱼ}ⱼ₌₁^{k} is first initialized, then a soft assignment of the feature point and the clustering center is calculated, and a KL divergence of the soft assignment and auxiliary distribution is calculated to update the clustering center μⱼ, and parameters θ and β.

In the present embodiment, a loss function is also included.

The loss function consists of two parts: (1) a reconstruction loss L_{R} used to update the network parameters of the encoder, convolutional auto-encoder, and convolutional variational auto-encoder; and (2) a clustering loss L_{C} used to update the clustering result, auto-encoder parameter and adaptive fusion parameter.

Reconstruction Loss

The model takes a square error function input by the encoder and output by the decoder as the reconstruction loss, and pre-trains the auto-encoder to obtain a good initialized model:

$${L}_{R} = {min}_{θ , ϑ , β} {\sum }_{i = 1}^{n} {‖ \overline{{x}_{i}} - {x}_{i} ‖}^{2}$$

wherein L_{R} represents a reconstruction loss function.

Clustering Loss

According to the reference “van der Maaten, Laurens and Hinton, Geoffrey. Visualizing data using t-SNE. JMLR, 2008”, the feature point Zᵢ and clustering center μⱼ are calculated using a student t assignment as a kernel function.

$${q}_{ij} = \frac{{( 1 + {‖ {Z}_{i} - {μ}_{j} ‖}^{2} / α )}^{- \frac{α + 1}{2}}}{{\sum }_{{j}^{′}} {( 1 + {‖ {Z}_{i} - {μ}_{j} ‖}^{2} / α )}^{- \frac{α + 1}{2}}}$$

wherein Zᵢ=∫(h(xᵢ)); α represents a degree of freedom of the student t assignment; qᵢⱼ can be interpreted as a probability of assigning a sample i to the clustering center j; μⱼ represents each center point; the clustering is iteratively optimized by learning from a high confidence assignment of the clustering with the help of the auxiliary target assignment, i.e., training our model by matching the soft assignment to the target assignment. An objective loss function is defined as the KL divergence between the soft assignment probability qᵢⱼ and the auxiliary distribution pᵢⱼ, expressed as:

$${L}_{C} = KL ( P \vert \vert Q ) = {\sum }_{i} {\sum }_{j} {p}_{ij} log \frac{{p}_{ij}}{{q}_{ij}}$$

wherein L_{C} represents a clustering loss function; qᵢⱼ represents a probability that the sample i belongs to the j class; and pᵢⱼ represents a target probability that the sample i belongs to the j class.
pᵢ is calculated by first raising qᵢ to second power and then by means of frequency normalization of each clustering, expressed as:

$${p}_{ij} = \frac{{q}_{ij}^{2} / {f}_{j}}{{\sum }_{j} {q}_{{ij}^{′}}^{2} / {f}_{{j}^{′}}}$$

$${f}_{j} = {\sum }_{i} {q}_{ij}$$

The training is divided into two stages, namely a pre-training initialization stage and a clustering optimization stage. In the pre-training initialization stage, the model is trained using the following loss function:

L₁=L_{R}

A loss function is used in the clustering optimization stage, expressed as:

L₂=L_{R}+L_{C}

When performing clustering, optimizing the function is further included, specifically including the following operations:
the clustering center {μⱼ} and the network parameter θ are jointly optimized by means of a stochastic gradient descent algorithm with momentum, and an L gradient embedded into a feature space of each data point Zᵢ and each clustering centroid μⱼ as follows:

$$\frac{\partial L}{\partial {Z}_{i}} = \frac{α + 1}{α} {\sum }_{j} {( 1 + \frac{{‖ {z}_{i} - {μ}_{j} ‖}^{2}}{α} )}^{- 1} \times ( {p}_{ij} - {q}_{ij} ) ( {z}_{i} - {μ}_{j} )$$

$$\frac{\partial L}{\partial {μ}_{j}} = - \frac{α + 1}{α} {\sum }_{i} {( 1 + \frac{{‖ {z}_{i} - {μ}_{j} ‖}^{2}}{α} )}^{- 1} \times ( {p}_{ij} - {q}_{ij} ) ( {z}_{i} - {μ}_{j} )$$

The gradient ∂L/∂Zᵢ is subjected to back propagation to calculate a network parameter gradient ∂L/∂θ, and in order to get the clustering assignment, when the number of points with the clustering assignment changed between two continuous iterations is smaller than a preset proportion of the total number of points, the clustering is stopped.

The present embodiment extracts different potential features through different encoders and fuses the features into the common subspace. After pre-training, an initialized adaptive feature fusion parameter β and an initialized model parameter θₘ are obtained, and then K-means clustering is executed on the common subspace Z after fusing to initialize the clustering center μⱼ.

### Embodiment II

The difference between the multi-modal adaptive fusion deep clustering model based on an auto-encoder and Embodiment I lies in that:
the model proposed in the present embodiment was validated on multiple datasets and compared to a number of excellent methods.

Dataset:
MNIST: the MNIST dataset consists of 70,000 handwritten digits having a size of 28×28 pixels. These numbers have been centered and size normalized as described in the reference “LeCun, Yann, Bottou, Le on, Bengio, Yoshua, and Haffner, Patrick. Gradient-based learning applied to document recognition. Proceedings of the IEEE, 86(11): 2278-2324, 1998”.
FASHION-MNIST: containing seventy thousand fashion product pictures from 20 categories, the picture size being the same as the MNIST, as in the reference “Xiao, H.; Rasul, K.; and Vollgraf, R. 2017. Fashion-mnist: a novel image dataset for benchmarking machine learning algo-rithms. arXiv preprint arXiv: 1708.07747”.
COIL-20: 20 categories of 1440 128×128 gray scale object images viewed from different angles are collected, as in the reference “Li, F.; Qiao, H.; and Zhang, B. 2018. Discriminatively boosted image clustering with fully convolutional auto-encoders. PR 83: 161-173”.

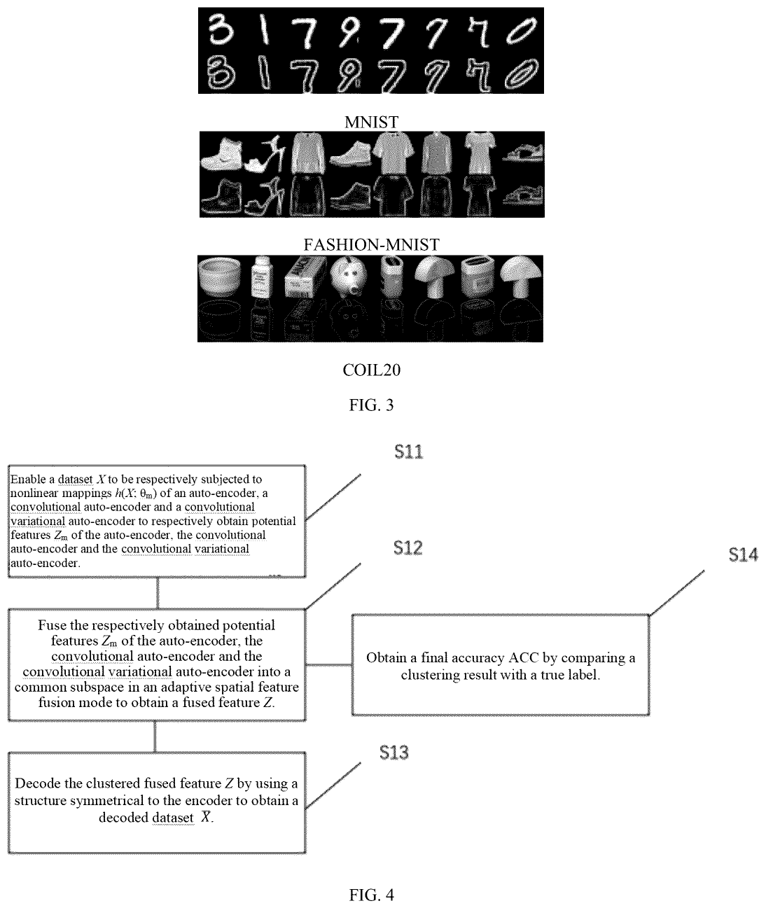

Specific dataset information and samples see Table 1 and FIG. 3.

TABLE 1
Dataset information

| Dataset | Number | Category | Image size |
|---|---|---|---|
| MNIST | 70000 | 10 | (28, 28, 1) |
| FASHION-MNIST | 70000 | 10 | (28, 28, 1) |
| USPS | 9298 | 10 | (16, 16, 1) |
| COIL20 | 1440 | 20 | (128, 128, 1) |

Evaluation Index

Another algorithm was evaluated and compared using a standard unsupervised evaluation index and protocol. For all algorithms, the number of clustering was set to the number of true categories, and the performance was evaluated using unsupervised clustering accuracy (ACC):

$$ACC = {max}_{m} \frac{{\sum }_{i = 1}^{n} 1 \{ {l}_{i} = m ( {c}_{i} ) \}}{n}$$

wherein lᵢ is the true label, Cᵢ is an algorithmically generated clustering assignment, and m covers all possible one-to-one mappings between clustering and labels.

The index intuitively takes the clustering assignment from an unsupervised algorithm and a basic truth assignment and then finds a best match therebetween. “Kuhn, Harold W. The hungarian method for the assignment problem. Naval research logistics quarterly, 2(1-2): 83-97, 1955” can efficiently calculate an optimal mapping.

Network Configuration

The auto-encoder, the convolutional auto-encoder and the convolutional variational auto-encoder are used as three single-modal deep network branches for an original image, and the specific network configuration is shown in Table 2.

TABLE 2
Network branching structure

| Network branch | Encoder structure |
|---|---|
| Auto-encoder | 500-500-2000-10 |
| Convolutional | Conv1(5 × 5 × 32, strides = 2)- |
| auto-encoder | Conv2(5 × 5 × 64, strides = 2)- |
| | Conv3(3 × 3 × 128, strides = 2)- |
| | flatten-10 |
| Convolutional | Conv1(2 × 2 × 1)- |
| variational | Conv2(2 × 2 × 6)- |
| auto-encoder | Conv3(3 × 3 × 20)- |
| | Conv3(3 × 3 × 60)- |
| | Flatten-256-10 |

TABLE 3
Vertical comparison of clustering performance
of different algorithms on three datasets
Algorithm comparison (vertical)

| | MNIST | | USPS | | Fashion-MNIST | |
|---|---|---|---|---|---|---|
| Methods | ACC | NMI | ACC | NMI | ACC | NMI |
| DEC | 0.8430 | 0.8372 | 0.7368 | 0.7529 | 0.5857 | 0.6309 |
| IDEC | 0.8421 | 0.8381 | 0.7210 | 0.7323 | 0.5926 | 0.6312 |
| DCEC | 0.8897 | 0.8849 | 0.7900 | 0.8257 | 0.5679 | 0.6218 |
| VaDE | 0.9446 | 0.8514 | 0.7768 | 0.8034 | 0.6260 | 0.6555 |
| MDEC | 0.9663 | 0.9168 | 0.8646 | 0.8206 | 0.6234 | 0.6495 |
| OURS | 0.9773 | 0.9383 | 0.9096 | 0.8600 | 0.6503 | 0.6559 |

TABLE 4
Horizontal comparison of clustering performance
of different algorithms on three datasets
Algorithm comparison (horizontal)

| | MNIST | | FASHION-MNIST | | COIL20 | |
|---|---|---|---|---|---|---|
| Methods | ACC | NMI | ACC | NMI | ACC | NMI |
| K-means | 0.546 | 0.495 | 0.512 | 0.499 | 0.668 | 0.626 |
| DEC | 0.844 | 0.816 | 0.518 | 0.546 | 0.737 | 0.753 |
| RMKMC | 0.592 | 0.658 | 0.533 | 0.528 | 0.609 | 0.749 |
| DCCA | 0.480 | 0.397 | 0.527 | 0.538 | 0.557 | 0.649 |
| DCCAE | 0.467 | 0.392 | 0.518 | 0.530 | 0.561 | 0.653 |
| DGCCA | 0.632 | 0.581 | 0.562 | 0.570 | 0.540 | 0.624 |
| DMJC | 0.960 | 0.931 | 0.620 | 0.647 | 0.730 | 0.816 |
| DMSC | 0.708 | 0.721 | 0.596 | 0.651 | 0.741 | 0.868 |
| MDEC | 0.966 | 0.916 | 0.623 | 0.649 | 0.742 | 0.823 |
| OURS | 0.977 | 0.938 | 0.650 | 0.656 | 0.803 | 0.831 |

Two unimodal clustering methods were selected: K-means, such as “J. A. Hartiganand M. A. Wong, “AlgorithmAS136: Ak-means clustering algorithm,” J. Roy. Stat. Soc. C, Appl. Stat., vol. 28, no. 1, pp. 100-108, 1979”, and deep embedding clustering (DEC), such as “J. Xie, R. Girshick, and A. Farhadi, “Unsupervised deep embedding for clustering analysis,” in Proc. Int. Conf. Mach. Learn., 2016, pp. 478-487″; a traditional large-scale multi-modal clustering method includes: robust multi-modal K-means clustering (RMKMC), such as “Cai, X.; Nie, F.; and Huang, H. 2013. Multi-view k-means clustering on big data. In IJCAI”; two deep two-mode clustering methods are: Deep canonical correlation analysis (DCCA), such as “Andrew, G.; Arora, R.; Bilmes, J.; and Livescu, K. 2013. Deep canonical correlation analysis. In ICML, 1247-1255”, and a Deep Canonical Correlation Auto-Encoder (DCCAE), such as “Wang, W.; Arora, R.; Livescu, K.; and Bilmes, J. 2016. On deep multi-view representation learning: objectives and opti-mization. arXiv preprint arXiv: 1602.01024”; and two deep multi-modal clustering methods are: Deep Generalized Canonical Correlation Analysis (DGCCA), such as “Benton, A.; Khayrallah, H.; Gujral, B.; Reisinger, D. A.; Zhang, S.; and Arora, R. 2017. Deep generalized canonical correlation analysis, arXiv preprint arXiv: 1702.02519”, and a joint framework of Deep multi-modal clustering (DMJC); deep multimodal sub-space clustering networks. IEEE Journal of Selected Topics in Signal Processing 12(6): 1601-1614. As a comparison with the algorithm proposed in the present embodiment, see Table 3, the method proposed in the present embodiment is also compared with the method proposed in the paper Multi-View Deep Clustering based on AutoEncoder (MDEC), the MDEC uses a Multi-View linear fusion method to fuse three views, the linear fusion method is simple and effective, but the weights of three different view features cannot be effectively constrained. However, the multi-modal adaptive fusion provided in the present implementation obtains the fusion parameter through convolution and softmax function, and can adjust the weight of each modal feature by means of back propagation, so that the classification accuracy is effectively improved.

The present implementation presents a novel multi-modal adaptive feature fusion deep clustering framework, and the framework includes a multi-modal encoder, an adaptive feature fusion network, and a deep clustering layer. Through the multi-modal encoder and the adaptive feature fusion layer, the model extracts original data features by means of nonlinear mapping, fulfills high-dimensional data dimensionality reduction, optimizes the common subspace of the data features, and finally constrains subspace clustering by using the KL divergence.

Experimental results on three common datasets demonstrated that the model in the present embodiment outperformed a plurality of the latest models.

### Embodiment III

The present embodiment provides a multi-modal adaptive fusion deep clustering method based on an auto-encoder, as shown in FIG. 4, including the following operations:

at S11, a dataset X is enabled to be respectively subjected to nonlinear mappings h(X; θₘ) of an auto-encoder, a convolutional auto-encoder and a convolutional variational auto-encoder to respectively obtain potential features Zₘ of the auto-encoder, the convolutional auto-encoder and the convolutional variational auto-encoder;

at S12, the respectively obtained potential features Zₘ of the auto-encoder, the convolutional auto-encoder and the convolutional variational auto-encoder are fused into a common subspace in an adaptive spatial feature fusion mode to obtain a fused feature Z;

at S13, the clustered fused feature Z is decoded by using a structure symmetrical to the encoder to obtain a decoded reconstructed dataset X̅; and

at S14, the fused feature Z is clustered, and a final accuracy ACC is obtained by comparing a clustering result with a true label.

It should be noted that the multi-modal adaptive feature fusion deep clustering method based on an auto-encoder provided in the present embodiment is similar to the embodiment, and will not be described herein again.

Compared with the prior art, the present embodiment provides a novel multi-modal adaptive fusion deep clustering framework, and the framework includes a multi-modal encoder, a multi-modal adaptive feature fusion network and a deep clustering layer. Through the multi-modal encoder and the fusion layer, the model extracts original data features by means of nonlinear mapping, fulfills high-dimensional data dimensionality reduction, optimizes the common subspace of the data features, and finally constrains subspace clustering by using the KL divergence. Experimental results on three common datasets demonstrated that the model in the present embodiment outperformed a plurality of the latest models.

It should be noted that the above is only the preferred embodiments of the present application and the principles of the employed technologies. It should be understood by those skilled in the art that the present application is not limited to the particular embodiments described herein, and those skilled in the art can make various obvious changes, rearrangements and substitutions without departing from the protection scope of the present application. Therefore, although the present application has been described in some detail by the above embodiments, it is not limited to the above embodiments, and may further include other equivalent embodiments without departing from the spirit of the present application, and the scope of the present application is determined by the scope of the appended claims.

What is claimed is:

1. A multi-modal adaptive fusion deep clustering model based on an auto-encoder, comprising an encoder, a multi-modal adaptive fusion layer, a decoder and a deep embedding clustering layer, wherein the encoder comprises an auto-encoder, a convolutional auto-encoder and a convolutional variational auto-encoder;
the encoder is configured to enable a dataset X to be respectively subjected to three types of nonlinear mappings h(X; θₘ) of the auto-encoder, the convolutional auto-encoder and the convolutional variational auto-encoder to obtain potential features Zₘ of the auto-encoder, the convolutional auto-encoder and the convolutional variational auto-encoder, respectively;
the multi-modal adaptive fusion layer is connected with the encoder and is configured to fuse the potential features Zₘ of the auto-encoder, the convolutional auto-encoder and the convolutional variational auto-encoder into a common subspace in an adaptive spatial feature fusion mode to obtain a fused feature Z;
the decoder is connected with the multi-modal adaptive fusion layer and is configured to decode the fused feature Z by using a structure symmetrical to the encoder to obtain a decoded reconstructed dataset X̅; and
the deep embedding clustering layer is connected with the multi-modal adaptive fusion layer and is configured to cluster the fused feature Z and obtain a final accuracy ACC by comparing a clustering result with a true label.

2. The multi-modal adaptive fusion deep clustering model based on the auto-encoder according to claim 1, wherein the potential features Zₘ of the auto-encoder, the convolutional auto-encoder and the convolutional variational auto-encoder respectively obtained in the encoder are expressed as:
Zₘ=h(X;θₘ)
wherein θₘ represents an encoder model parameter; and m represents an encoder sequence and has a value range of {1,2,3}.

3. The multi-modal adaptive fusion deep clustering model based on the auto-encoder according to claim 2, wherein the fused feature Z obtained in the multi-modal adaptive fusion layer is expressed as:
Z=ω₁·Z₁+ω₂·Z₂+ω₃·Z₃
wherein ωₘ represents an importance weight of a feature of an mth modal, and an adaptive feature fusion parameter is obtained by adaptive learning of a network;
Σₘ₌₁³ωₘ=1,ωₘ∈[0, 1] is limited, and
$${ω}_{m} = \frac{{e}^{{β}_{m}}}{{e}^{{β}_{1}} + {e}^{{β}_{2}} + {e}^{{β}_{3}}}$$
is defined,
wherein ωₘ is defined by using a softmax function with βₘ as a control parameter, respectively; and a weight scalar βₘ is calculated by using 1×1 convolution on different modal features, respectively, and learning is achieved by standard back propagation.

4. The multi-modal adaptive fusion deep clustering model based on the auto-encoder according to claim 3, wherein the decoded reconstructed dataset X̅ obtained in the decoder is expressed as:
X̅=g(Z;θₘ)
wherein θₘ represents a decoder model parameter.

5. The multi-modal adaptive fusion deep clustering model based on the auto-encoder according to claim 4, wherein the step of clustering the fused feature Z in the deep embedding clustering layer comprises:
dividing n points {xᵢ∈X}ᵢ₌₁ⁿ into k classes, using μⱼ, j=1, . . . , k for a center of each class, initializing a clustering center {μⱼ}ⱼ₌₁^{k}, calculating a soft assignment qᵢⱼ and an auxiliary distribution pᵢ of the feature points and the clustering center, finally defining a clustering loss function by using a Kullback-Leibler (KL) divergence of the soft assignment qᵢⱼ and the auxiliary distribution pᵢ, and updating the clustering center μⱼ, the encoder, the decoder parameter θ and the adaptive feature fusion parameter β.

6. The multi-modal adaptive fusion deep clustering model based on the auto-encoder according to claim 5, wherein the encoder further comprises updating network parameters of the auto-encoder, the convolutional auto-encoder and the convolutional variational auto-encoder by using a reconstruction loss, wherein a square error function of original data xᵢ input by the encoder and reconstruction data x̅ᵢ output by the decoder is used as the reconstruction loss, the encoder is pre-trained, and an initialized model is obtained and expressed as:
$${L}_{R} = {min}_{θ , ϑ , β} {\sum }_{i = 1}^{n} {‖ \overline{{x}_{i}} - {x}_{i} ‖}^{2}$$
wherein L_{R} represents a reconstruction loss function.

7. The multi-modal adaptive fusion deep clustering model based on the auto-encoder according to claim 6, wherein the deep embedding clustering layer further comprises updating the clustering result, encoder parameter and fusion parameter by using a KL divergence of the clustering loss, wherein
a student t assignment is used as a kernel function to calculate a similarity between the feature point Zᵢ and the clustering center μⱼ, wherein the kernel function is expressed as:
$${q}_{ij} = \frac{{( 1 + {‖ {Z}_{i} - {μ}_{j} ‖}^{2} / α )}^{- \frac{α + 1}{2}}}{{\sum }_{{j}^{′}} {( 1 + {‖ {Z}_{i} - {μ}_{j} ‖}^{2} / α )}^{- \frac{α + 1}{2}}}$$
wherein Zᵢ=∫(h(xᵢ))∈Z; α represents a degree of freedom of the student t assignment; qᵢⱼ represents a probability of assigning a sample i to the clustering center μⱼ; and μⱼ represents each center point; and
the clustering is iteratively optimized by learning from a high confidence assignment of the clustering with the help of an auxiliary target assignment, i.e., training the model by matching the soft assignment to the target assignment, and an objective loss function is defined as the KL divergence between the soft assignment probability qᵢ and the auxiliary distribution pᵢ, and expressed as:
$${L}_{C} = KL ( P \vert \vert Q ) = {\sum }_{i} {\sum }_{j} {p}_{ij} log \frac{{p}_{ij}}{{q}_{ij}}$$
$${p}_{ij} = \frac{{q}_{ij}^{2} / {f}_{j}}{{\sum }_{j} {q}_{{ij}^{′}}^{2} / {f}_{{j}^{′}}}$$
$${f}_{j} = {\sum }_{i} {q}_{ij}$$
wherein L_{C} represents a clustering loss letter, and fⱼ=Σᵢqᵢⱼ represents a soft clustering frequency.

8. The multi-modal adaptive fusion deep clustering model based on the auto-encoder according to claim 7, wherein the deep embedding clustering layer further comprises:
jointly optimizing the clustering center μⱼ, network parameter θ and adaptive feature fusion parameter β by a stochastic gradient descent algorithm with momentum, and calculating an L gradient embedded into a feature space of each data point Zᵢ and each clustering center μⱼ as follows:
$$\frac{\partial L}{\partial {Z}_{i}} = \frac{α + 1}{α} {\sum }_{j} {( 1 + \frac{{‖ {z}_{i} - {μ}_{j} ‖}^{2}}{α} )}^{- 1} \times ( {p}_{ij} - {q}_{ij} ) ( {z}_{i} - {μ}_{j} )$$
$$\frac{\partial L}{\partial {μ}_{j}} = - \frac{α + 1}{α} {\sum }_{i} {( 1 + \frac{{‖ {z}_{i} - {μ}_{j} ‖}^{2}}{α} )}^{- 1} \times ( {p}_{ij} - {q}_{ij} ) ( {z}_{i} - {μ}_{j} )$$
wherein a gradient ∂L/∂Zᵢ is subjected to back propagation to calculate a network parameter gradient ∂L/∂θ, and when a number of points with clustering assignment changed between two continuous iterations is smaller than a preset proportion of a total number of points, the clustering is stopped.

9. A multi-modal adaptive fusion deep clustering method based on an auto-encoder, comprising:
S1, enabling a dataset X to be respectively subjected to nonlinear mappings h(X; θₘ) of an auto-encoder, a convolutional auto-encoder and a convolutional variational auto-encoder to respectively obtain potential features Zₘ of the auto-encoder, the convolutional auto-encoder and the convolutional variational auto-encoder;
S2, fusing the potential features Zₘ of the auto-encoder, the convolutional auto-encoder and the convolutional variational auto-encoder into a common subspace in an adaptive spatial feature fusion mode to obtain a fused feature Z;
S3, decoding the clustered fused feature Z by using a structure symmetrical to the encoder to obtain a decoded dataset X̅; and
S4, clustering the adaptive fused feature Z, and obtaining a final accuracy ACC by comparing a clustering result with a true label.

10. The multi-modal adaptive fusion deep clustering method based on the auto-encoder according to claim 9, wherein the fused feature Z obtained in S2 is expressed as:
Z=ω₁·Z₁+ω₂·Z₂+ω₃·Z₃
wherein ωₘ represents an importance weight of a feature of an mth modal, and an adaptive feature fusion parameter is obtained by adaptive learning of a network;
Σₘ₌₁³ωₘ=1, ωₘ∈[0, 1] is limited, and
$${ω}_{m} = \frac{{e}^{{β}_{m}}}{{e}^{{β}_{1}} + {e}^{{β}_{2}} + {e}^{{β}_{3}}}$$
is defined,
wherein ωₘ is defined by using a softmax function with βₘ as a control parameter, respectively; and a weight scalar βₘ is calculated by using 1×1 convolution on different modal features, respectively, and learning is achieved by standard back propagation.
